(19) United States
(12) Patent Application Publication
(10) Pub. No.: US 2014/0190624 A1
(43) Pub. Date: Jul. 10, 2014

(54) MECHANISM FOR AUTOMATICALLY CUTTING AND PLACEMENT OF RESIN IMPREGNATED FIBERS

(71) Applicants: Samoil Samak, Prilep (MK); Blagoja Samkoski, Prilep (MK); Zlatko Sokoloski, Prilep (MK); Gari Maneski, Prilep (MK)

(72) Inventors: Samoil Samak, Prilep (MK); Blagoja Samkoski, Prilep (MK); Zlatko Sokoloski, Prilep (MK); Gari Maneski, Prilep (MK)

(73) Assignee: TEKON D.O.O., Prilep (MK)

(21) Appl. No.: 14/238,568

(22) PCT Filed: Feb. 15, 2012
(86) PCT No.: PCT/MK2012/000002

§ 371 Date: Feb. 12, 2014

(30) Foreign Application Priority Data
Feb. 15, 2011 (MK) MK/P/2011/51

(51) Int. Cl. B29C 70/38; B29C 70/32

(52) U.S. Cl. CPC B29C 70/384; B29C 70/32
USPC 156/193; 156/449; 156/475

(57) ABSTRACT

Mechanism for automatically cutting and placement of resin impregnated fibers in a carrier setting to the carriage that moves longitudinally and transversely relative to the axis of the wound part and where is provided more pneumatic cylinders one of which is rotational and other are used for longitudinal movement of the components mounted of the guides, for linear motion and implication and extraction of the fiber hold bed, for opening and closing the knife and the moving of pressure roller.

### TECHNICAL FIELD TO WHICH THE INVENTION RELATES

The invention relates to the field of performing operations. According to International Patent Classification (IPC) the invention can be classified in the section of processing of plastic materials or processing materials in a plastic condition. The invention belongs to the group of forming with a winding that can be classified with the classification symbol B29C 53/00.

The invention can also be classified in the same section or in the subgroup of reshaping with manual placement or laying of fiber. The label in this case would be B29C 70/30.

### Technical Problem which is Solved by the Invention

In the current state of the art winding and placing the fibers on the surface of the part which has to be winded with “Filament Winding” and fibers cutting are performed manually. The mechanism that is revealed and described in this specification solves this problem. By applying this mechanism, the manual operation of cutting impregnated fibers is replaced by machines. Also, in the current state of the technology the operations for winding and placing the fibers repeat for each new winding. Using this mechanism, the process is completely automated and thereby preparatory time before winding is reduced which is quite useful if it is used in machines that can simultaneously wind more parts.

### STATE OF THE ART

Filament winding means production of parts consisting of high volume parts and controlled orientation of the fibers. Typically, the fibers are impregnated in resin and then bet with light or heavy reagents. Impregnated fibers then are wound around mandrel literally, in a controlled pattern in order to form the shape of the part. After winding, the resin is reacted, usually using heat. Molds can be removed or can be left as an integral component of the part. This process is primarily used for hollow, mainly circular or oval components, such as pipes and tanks. Pressure vessels, pipes and drive shafts are usually manufactured using filament winding. It is combined with other fiber application methods such manual placement and knitting. Tamponing is through fiber tension and resin content is mainly (Rosato, DV) standard. Fibers can be impregnated with resin before winding (wet winding), pre impregnated (dry winding) or post-impregnated. Wet winding has advantages of low cost of materials with a long shelf-life and low viscosity. Pre-impregnated systems produce parts with more consistent resin content and can often be faster wound.

In the all above mentioned cases described above regardless of what kind of winding is done, it is performed manually. This patent application reveals that if the invention is applied in the production process it will allow automation of cutting and restart of fibers on wound part which, until now was performed manually and require human involvement and repeat the process with each new winding. In this invention the first implementation of impregnated fibers through the mechanism, the operator does manually, then the whole process of cutting and placing the fibers on the surface of the wound part for any subsequent winding is done automatically.

This mechanism should be counted only as an additional device that is mounted on the machines and it should not be identified with certain inventions that define the way of winding. The essence of the invention is in the replacement of manual work of cutting and automation of the process.

### DESCRIPTION OF THE TECHNICAL SOLUTION OF THE PROBLEM

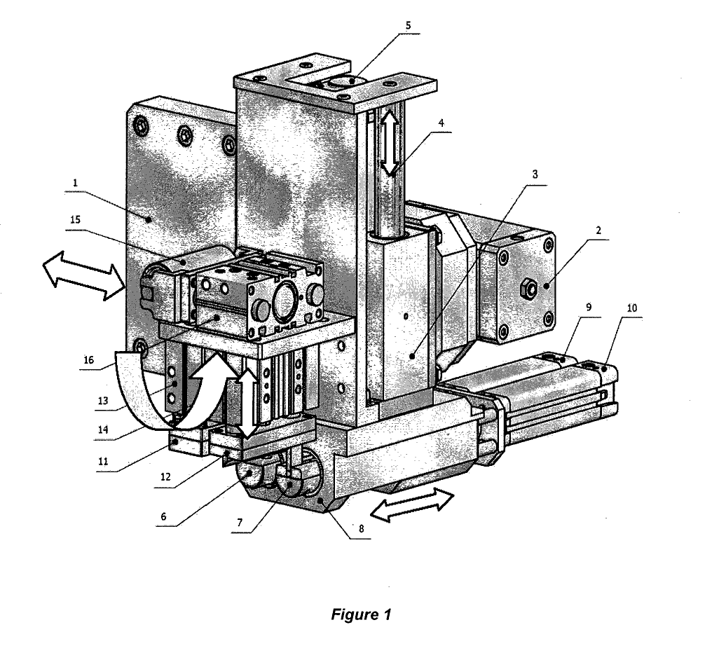

For better description of the essence of the technical solution to this invention, we will use FIG. 1 which shows the mechanism for automatically cutting and placement of wax impregnated fibers which comprises the following components:
1. Carrier mechanism
2. Rotational pneumatic cylinder
3. Bearing for linear motion
4. Guide
5. Pneumatic cylinder for linear motion
6. Fiber hold bed
7. Fiber cut bed
8. Housing of fiber hold bed and fiber cut bed
9. Pneumatic cylinder to move the fiber hold bed
10. Pneumatic cylinder to move the fiber cut bed
11. Fiber holder
12.Knife
13. Pneumatic cylinder that move fiber holder
14. Pneumatic cylinder that move the knife
15. Pressure roller
16. Pneumatic cylinder that move the roller

### The Above Mentioned Components of the Mechanism Have the Following Function

Carrier (1) is used for mechanism to be set to the carriage which can move longitudinally and transversely relative to the axis of the wound part. Rotational pneumatic cylinder (2) allows rotation of all components. Pneumatic cylinder (5) performs linear motion of all components. Pneumatic cylinder (9) allows linear motion or implication the fiber hold bed (6) and pull it out until pneumatic cylinder (10) allow implication the fiber cut bed (7) and pull it out. The opening and closing of fiber holder is allowed by pneumatic cylinder (13), while opening and closing of the knife is allowed by pneumatic cylinder (14). Movement of pressure roller (15) is performed by pneumatic cylinder (16).

Implementation of the impregnating fibers through the mechanism, shall be performed by the operator and the operator does manually, and then the whole process of cut and restart the fibers on the surface of the wound part (17) for each successive winding is done automatically.

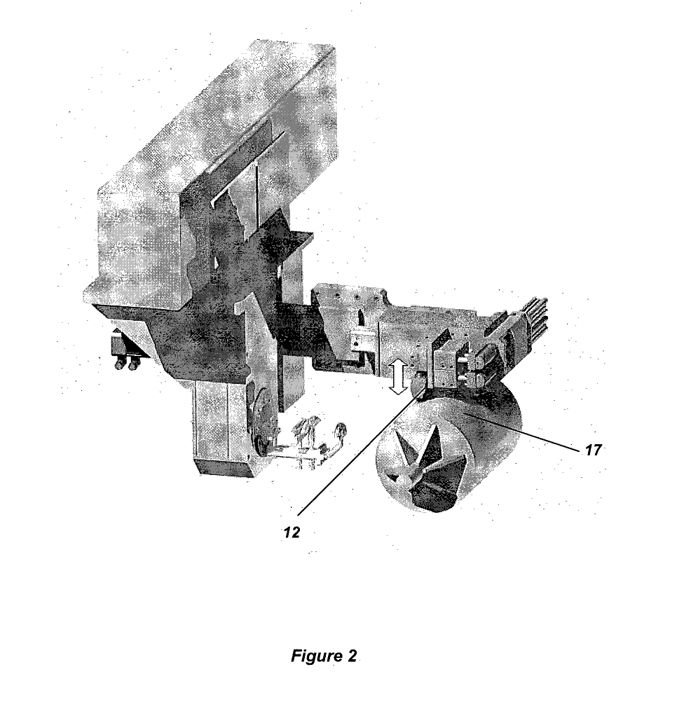

Below mentioned explanation describes the operating principle of this mechanism in a winding section (17) with fiber impregnated with resin. FIG. 2 should give an understanding of the mechanism when it is mounted on a suitable machine and it is in working position and by using a knife (12) automatically cutting the fibers that is the essence of the described invention.

As previously stated, the first implementation of impregnated fibers through the mechanism shall be performed by the operator and it is performed manually. Pneumatical cylinder (5) moving down components set on the guides (4), so press the fibers down causing them to central axis of the part (17) which should be wound. Furthermore, follow extraction of fiber hold bed and fiber cut bed under the fibers which is done by the cylinder (9) and (10). Fiber holder (11) press the fibers on the matrix (6), while the knife (12) moves down and cut the fibers. The fibers remain caught between fiber holder (12) and matrix (7). Now, all components mounted on guides (4) together with the caught ends of the fibers are moved up by the cylinder (5), and rotated for 90° in conter clockwise rotation with the rotational cylinder (2). After that follow simultaneous double moving ahead to the axis of the section (17) which has to be wound. In the first step the whole mechanism is moved with the carriage on which is mounted, and then the components mounted on the guides (4) are moved by the cylinder (5) which is in horizontal position and together moving forward. Thus, caught fibers are carried over the part (17) which should be wound, passes its symmetry axis, while pressure roller (15) is positioned over the center axis of the section. Pressure roller (15) with the cylinder (16), press the fibers on the surface of section (17) while fiber holder (11) move up. The fibers are delivered (free) from the mechanism and stay between pressure roller (15) and surface of the wounded part (17). Follow winding process which includes clockwise rotation of the part in order ends of impregnated fibers drop on wounded part to come under pressure roller, and then is performed rotation of the part, but in opposite direction. After that and when the impregnated fibers overlaping, the pressure roller (15) going up and the whole mechanism goes into the starting possition. During the winding process, the presure roller along with the carriage is withdrawn on the side. When the winding process is finished, the whole process starting from the begining.

1. Mechanism for automatically cutting and placement of resin impregnated fibers wherein it is provided at least one carrier (1) that serves mechanism to be set to the carriage which can move longitudinally and transversely relative to the axis The wound part and where is provided more pneumatic cylinders one of which is rotational (2) allows rotation of all components until pneumatic cylinder (5) performs linear motion of all components, the cylinder (9) allows linear motion or implication the fiber hold bed (6) to pull it out cylinder (14) allows opening and closing of fiber holder, cylinder (14) allows opening and closing of the knife, cylinder (16) allows movement of pressure roller (15).

2. Mechanism for automatically cutting and placement of resin impregnated Fibers wherein the pneumatic cylinder (5) provide move sown of all components that are attached to the guides (4) and simultaneously pressing the fibers positioned in the central axis of the part that should be wound.

3. The procedure in accordance to patent claim 2, wherein extraction of fiber hold bed and fiber cut bed under the fibers, is done by the cylinder (9) and (10) while fiber holder (11) press the fibers on the fiber hold bed (6), the knife (12) move down and cut the fibers.

4. The procedure in accordance to claim 2 wherein the components are mounted on guides (4) together with the caught ends of the fibers are moved up by the cylinder (5), and rotated for 90° in center clockwise rotation with the rotational cylinder (2).

5. The procedure in accordance to claim 1 characterized that includes moving of the whole mechanism with the carriage on which is mounted, and then the components mounted on the guides are moved by the cylinder (5) which is in horizontal position and moving forward whereby caught fibers are carried over the part which should be wound, passes his symmetry axis, while pressure roller (15) is positioned over the center axis of the part.

6. The procedure in accordance to claim 1 characterized that pressure roller (15) with the cylinder (16), press the fibers on the surface of part, while fiber holder (11) moves up.

7. The procedure in accordance to claim 1 characterized with winding process that includes clockwise rotation of the part (17) in order ends of impregnated fibers drop on wounded part to come under pressure roller, and then is performed rotation of the part, but in opposite direction and after one performed rotation and when the impregnated fibers overlapping. the pressure roller (15) going up and the whole mechanism goes into the starting position.

8. The procedure in accordance to claim 3, wherein the components are mounted on guides (4) together with the caught ends of the fibers are moved up by the cylinder (5) and rotated for 90° in counter clockwise rotation with the rotational cylinder (2).

9. The procedure in accordance to claim 4, characterized that includes moving of the whole mechanism with the carriage on which is mounted, and then the components mounted on the guides (4) are moved by the cylinder (5) which is in horizontal position and moving forward whereby caught fibers are carried over the part which should be wound, passes his symmetry axis, while pressure roller (15) is positioned over the center axis of the part.

10. The procedure in accordance to claim 5 characterized that pressure roller (15) with the cylinder (16), press the fibers on the surface of part, while fiber holder (11) moves up.

11. The procedure in accordance to claim 4, are characterized with winding process that includes clockwise rotation of the part (17) m order ends of impregnated fibers drop on wounded part to come under pressure roller, and the is performed rotation of the part, but in opposite direction and after one performed rotation and when the impregnated fibers overlaping, the pressure roller (15) going up and the whole mechanism goes into the starting position.
